(19) United States
(12) Patent Application Publication
(10) Pub. No.: US 2025/0381661 A1
(43) Pub. Date: Dec. 18, 2025

(54) DISTRIBUTED ROBOT CONTROLLER

(71) Applicant: Dexterity, Inc., Redwood City, CA (US)

(72) Inventors: Zhouwen Sun, San Mateo, CA (US); Samir Menon, Atherton, CA (US); Nirmal Sharma, Sunnyvale, CA (US); Andrew Nguyen, San Francisco, CA (US)

(21) Appl. No.: 19/236,773

(22) Filed: Jun. 12, 2025

Related U.S. Application Data
(60) Provisional application No. 63/660,223, filed on Jun. 14, 2024.

(51) Int. Cl. B25J 9/16; B25J 5/00; B25J 13/08; H02P 5/68

(52) U.S. Cl. CPC B25J 9/1602; B25J 5/007; B25J 13/085; H02P 5/68

(57) ABSTRACT

A distributed robot controller is disclosed, comprising a plurality of local controllers, each associated with a corresponding motor included in a plurality of motors comprising a robot; and a robot level controller coupled communicatively with each of the local controllers and configured to determine a plan to operate the plurality of motors to cause the robot to perform a task and send to each of the local controllers included in the plurality of local controllers at least a set of one or more torques associated with the motor with which that local controller is associated.

### CROSS REFERENCE TO OTHER APPLICATIONS

This application claims priority to U.S. Provisional Patent Application No. 63/660,223 entitled DISTRIBUTED ROBOT CONTROLLER filed Jun. 14, 2024, which is incorporated herein by reference for all purposes.

### BACKGROUND OF THE INVENTION

Advanced robotic systems that manipulate items in a work space, e.g., applications involving pick and place tasks, including without limitation robots that perform logistics applications such as palletization/depalletization, singulation/sortation, truck or other container loading/unloading, line kitting, and the like, use industrial robots such as robotic arms equipped with end effectors suited to picking, moving, and placing items in the workspace.

Typically, a control computer determines a plan and schedule to use the robot to pick, move, and place items, as needed, to achieve a higher-level objective, such as to load or unload a pallet or container. For each item, a set of tasks is determined to move the robotic arm and its end effector to the item, grasp (pick) the item, move it through a trajectory to a destination location, and place the item in the destination location.

Most commonly, “position control” is used to control the robotic arm (or other robot) to perform the determined set of tasks. Typically, a robotic arm (or other robot) includes a robot controller configured to receive a command, such as from a control computer, to move an item from a start position through a trajectory (e.g., a set of intermediate positions) to a destination position, and then place (ungrasp) the item at the destination location. The robot controller uses (or embodies) a model of the capabilities and constraints of the robotic arm (or other robot) to determine the sequence, timing, and magnitude of the current to be supplied to the various joint motors comprising the robot to cause the end effector/item to be moved through the trajectory.

The robot controller sends lower-level commands to the respective motor drivers associated with the joint motors, in response to which the motor drivers cause the required current(s) to be supplied at the required time(s).

Closed loop feedback control is used to minimize/close the difference between the actual position/state and the expected/desired position as the robotic arm and end effector are moved through the trajectory.

Sensor data is used to provide the feedback needed to control the robot. For example, cameras or other image sensors; encoders used to indicate/determine motor position, speed, and direction; force/torque sensors to measure the force(s)/torque(s) experienced at the end effector/payload; etc.

Typically, sensors generate and provide data at rates much higher than the rate at which control decisions can be made and implemented by a traditional robot controller.

### BRIEF DESCRIPTION OF THE DRA WINGS

Various embodiments of the invention are disclosed in the following detailed description and the accompanying drawings.

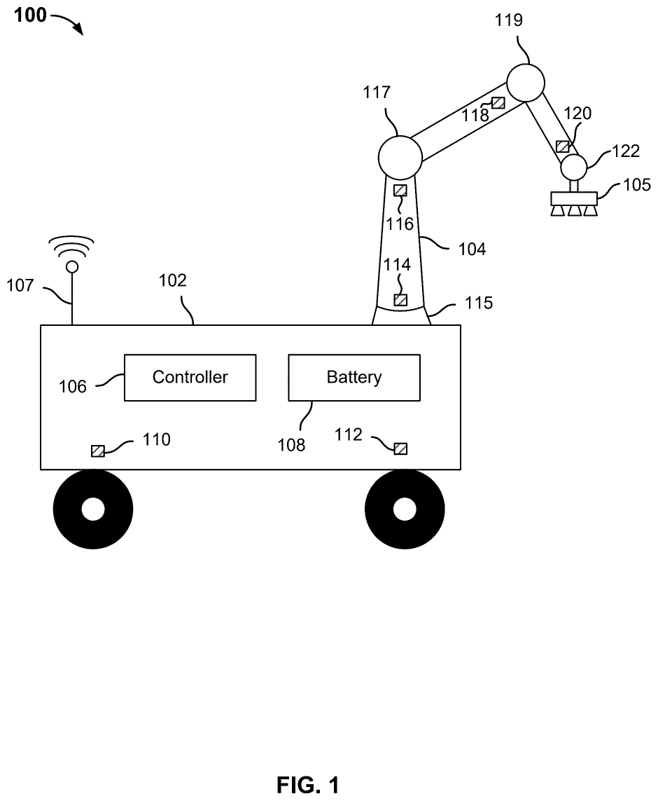

FIG. 1 is a diagram illustrating an embodiment of a robotic system comprising a distributed robotic controller.

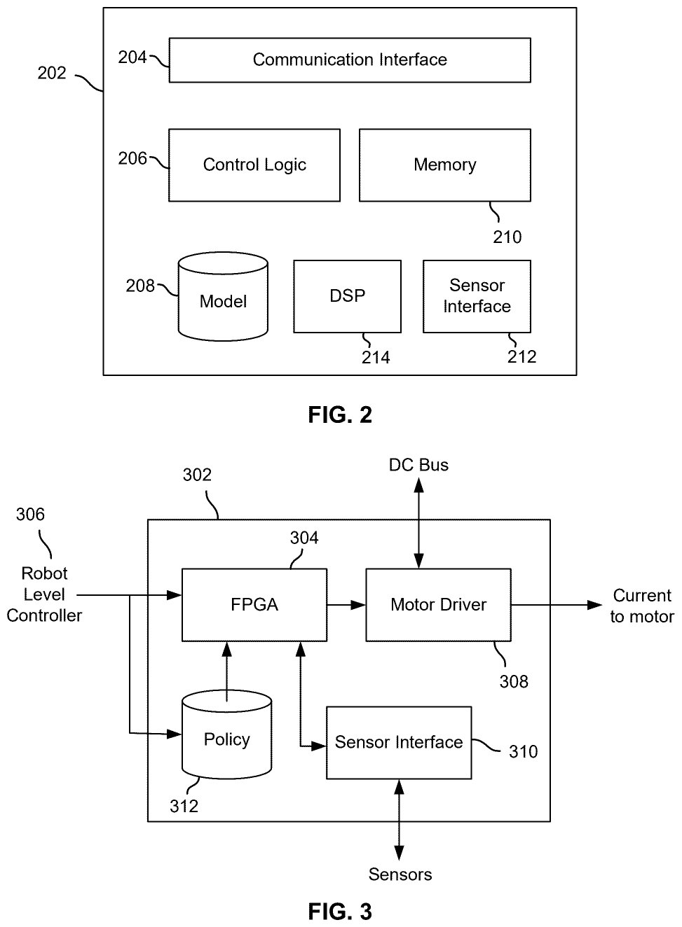

FIG. 2 is a block diagram illustrating an embodiment of a distributed robotic controller.

FIG. 3 is a block diagram illustrating an embodiment of a distributed robotic controller.

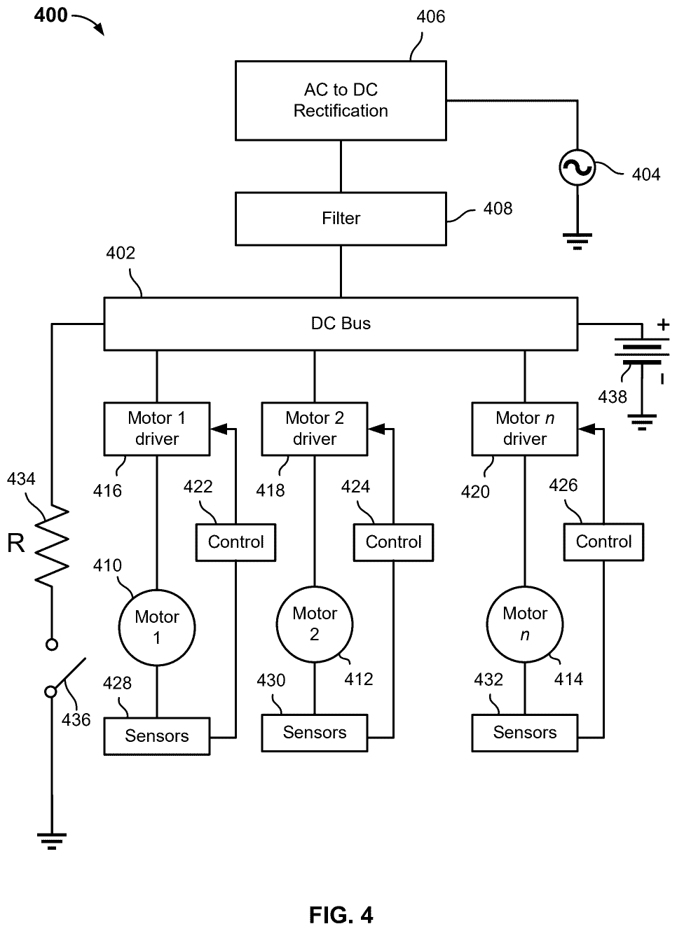

FIG. 4 is a diagram illustrating an embodiment of a robotic system comprising a distributed robotic controller and a shared DC bus.

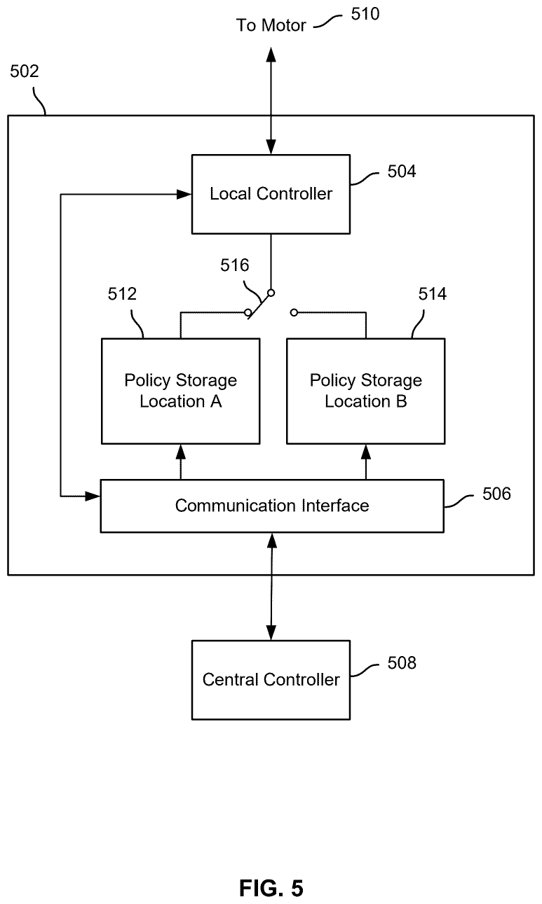

FIG. 5 is a block diagram illustrating an embodiment of a distributed robotic controller.

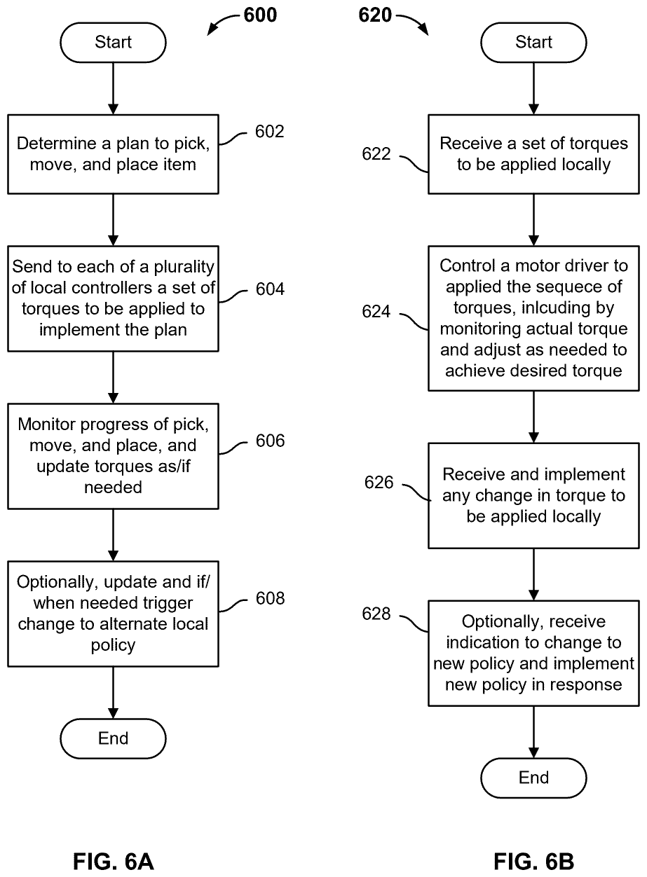

FIG. 6A is a flow diagram illustrating an embodiment of a process to control a robot via a distributed robotic controller.

FIG. 6B is a flow diagram illustrating an embodiment of a process to participate in control of a robot as a local controller comprising a distributed robotic controller.

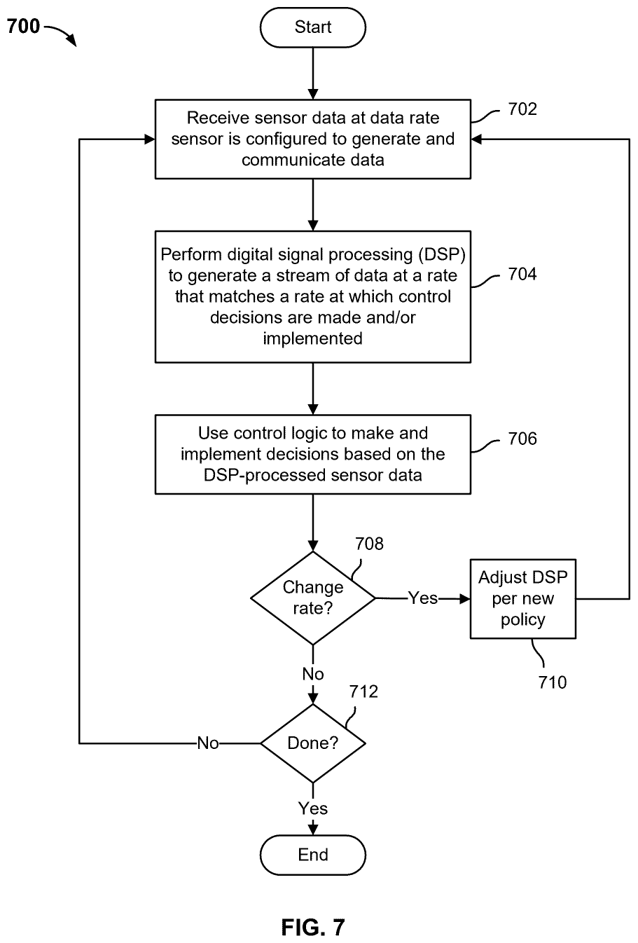

FIG. 7 is a flow diagram illustrating an embodiment of a process to participate in control of a robot as a local controller comprising a distributed robotic controller.

### DETAILED DESCRIPTION

The invention can be implemented in numerous ways, including as a process; an apparatus; a system; a composition of matter; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

A distributed robot controller and robotic systems and techniques that employ such a controller are disclosed. In various embodiments, a robotic system as disclosed herein comprises one or more controllers, each positioned and configured to control a subpart of the robotic system that is local to the controller. For example, a controller as disclosed herein may be positioned near a given joint or other element comprising a robotic arm.

In some embodiments, each joint comprising a robotic arm may be controlled by a local robotic controller configured to compute and cause torques to be applied to one or more joint motors comprising the joint. The controller may further be configured to receive and process sensor signals/output, such as image data from a nearby camera mounted on or near the joint or force/torque readings from a force/torque sensor positioned on or near the joint.

In some embodiments, a controller as disclosed herein may be implemented as an ASIC, FPGA, or other semiconductor device. For example, an FPGA may be programmed to perform robotic control functions, such as applying torque(s) to the joint by supplying current to the joint motor(s). A higher-level controller may indicate the torques to be applied, and actual control of the current being supplied to the motor may be controlled locally, by the local controller.

In various embodiments, a distributed/local controller as disclosed herein may be configured to control local elements comprising the robotic system (e.g., local joint motor(s), cameras and/or other sensors) at least in part based on feedback determined locally based on locally generated and processed sensor signals. For example, a controller as disclosed herein may employ digital signal processing (DSP) techniques to derive a clean, actionable feedback signal from typically noisy sensor readings.

In various embodiments, the way a local controller fulfills its local responsibility under a plan/trajectory to perform a task, e.g., by controlling the supply of current to a local joint motor, may be determined at least in part by a policy the local controller is configured to apply. For example, the policy may prescribe a way the controller will operate given the state and/or sensor signal(s) known to the controller at the time. The controller may be configured to make decisions autonomously, based on feedback received locally, within any constraints or other parameters prescribed by the policy currently in force.

In some embodiments, a policy as described above may be supplied by a higher level (e.g., robotic arm or system level controller). The policy may be swapped out dynamically, during runtime, e.g., by writing a new policy to a “staging” storage location and telling the controller to switch to stop enforcing the superseded policy and begin enforcing the policy that was written to the staging location. To make a further change in policy, the policy superseded by the policy written to the staging location could be overwritten with a replacement policy, etc.

In some embodiments, the DSP (or equivalent) portion of a local controller as disclosed herein may apply one or more DSP algorithms to incoming signals, such as the image data or output data generated by other sensors. A policy as described above may indicate an algorithm to be applied or may for each of a plurality of algorithms indicate circumstances in which that algorithm should be applied.

In some embodiments, DSP techniques may be used to estimate first, second, or other order derivatives of sensed position and/or other values. For example, the direction and rate of change in force or torque may be estimated, or the velocity and/or acceleration may be estimated based on DSP applied to position readings. In various embodiments, such deviates may be used to make and/or anticipate robot and/or joint control decisions.

A local controller as disclosed herein may be able to change not only the way that sensor values are processed, but also how the sensor itself behaves. For example, a camera may be set to a different frame rate or a force or position sensor may be set to generate readings or samples at a different rate.

In various embodiments, local controllers as disclosed herein are used in a distributed architecture that enables control decisions to be made and effectuated as close as possible to one or both of the instrumentality being controlled (e.g., joint motor) and the sensors that provide the feedback used to make/update the control decisions.

In addition, in various embodiments, a local controller as disclosed herein is configured to make/update and implement control decisions at or near (or at least nearer than in a traditional controller) a speed that matches (or more nearly matches) the rate at which feedback is received, e.g., from sensors.

For example, a traditional controller may be able to make decisions at rates on the order of 10 to 1000 Hz (i.e., 1 kHz), while sensors may provide information at a rate on the order of 100 kHz. In some embodiments, a local controller as disclosed herein may filter sensor output resulting in a filtered signal on the order of 50 or 25 kHz, and the control processes of the local controller at or near the same rate. For example, a current control loop operating at 100 kHz may be able to change the current (and resulting motor torque) at a rate of 50-70 kHz, i.e., a rate that matches the sensor signal rate orders of magnitude more closely than a traditional controller.

In various embodiments, DSP and/or control processing frequency may be varied, dynamically, e.g., in response to conditions. For example, for gross movements through unobstructed space, e.g., translating an item from a start location once it has been grasped to the vicinity of the destination location at which the item will be placed, the DSP may be configured to filter the sensor signal(s) less aggressively. By contrast, to perform close work requiring high sensitivity and/or dexterity, such as sliding a box into a position snugly between two other boxes, or working a key into a keyhole, the local controller(s) may be configured to update one or both of the sensor information and the control loop more quickly. The latter approach uses higher processing resources selectively, i.e., more intensively only if/when needed.

In various embodiments, a local controller as disclosed herein may be configured to record and/or report data that may be useful in managing (e.g., maintaining) a robotic system and/or a fleet of robotic systems. For example, usage data, sensor readings, etc. may be reported to a central, enterprise and/or fleet wide data store. AI/ML may be used to derive information from the data.

In various embodiments, a robotic interface as described above comprises one or both of the following components:
A hardware<->software interface standard that allows robots to be controlled intelligently with hybrid force-motion control, allowing complex AI algorithms to perform tasks at the capability of humans or beyond.
A hardware and software standard for robots tailored to the price-performance and interaction characteristics needed for smart, high-performance robotics for warehousing, logistics, consumer, and beyond.

In various embodiments, a distributed robot controller as disclosed herein is used to adapt robot behavior dynamically based on context. For example, a robot as disclosed herein may process, consume, and make and implement control decisions, at each of a plurality of local controllers, at a lower frequency while making gross movements, e.g., translating an item across a large open space, then shift to processing sensor data and making control decisions at a much higher rate once the item is being placed in its destination. Upon sensing contact with a surface at the destination, the robot controllers may shift to higher rates of processing as/if needed to pack the item more snugly against an adjacent item, or to shove the item into a tight space between two other items, etc. For example, force sensors may provide signals that enable the local controller(s) to detect contact. Force/torque computations may be performed at a higher rate to make fine adjustments and/or to fit the item into a space. Sensor data may be processed more quickly, for example, to detect when the force of static friction has been overcome and/or to ensure an appropriate amount of force is applied to continue to slide the item into place, overcoming kinetic friction. If a hard (non-compliant) surface is encountered, higher rates of signal processing and/or control decision making and implementation may be used, e.g., to avoid overshooting placement of an item, which can result in oscillation instead of smooth and continuous motion ending in a definitive placement without oscillation.

In another example, a robot as disclosed herein may be used to lift a delicate glass bottle with a gentle but firm grip. Or the robot may be used to slide a crate of eggs into place with a gentle but insistent push. The same robot may have the strength and endurance to lift 70 lb. cases repeatedly and reliably. In various embodiments, a robot controller as disclosed herein enables a robot to adapt dynamically to the conditions and task at hand, e.g., transform a stiff industrial robot (e.g., doing heavy work and/or gross movements) into a highly sensitive, responsive/reactive, and gentle instrumentality capable of handling very fragile items and/or performing tasks requiring high dexterity.

In various embodiments, a robotic system as disclosed herein provides and/or enables one or more of the following:
Force Control
   Gentle touch and multi robot collaborative lifting
Critical motion
   Thorough trajectory optimization
   Understanding of robot dynamics and limits
Multi-robot coordination
Robot-Sensor-Fusion
Standardization of error handling, robot protection, and edge-cases

In various embodiments, a robotic interface as disclosed herein may be implemented at least in part via a client (i.e., client software) in their firmware. A Hardware Abstraction Layer (HAL) then talks to the client implementation of the interface over a physical interface such as EtherCAT. AI Robotics software can now control the robot and its peripherals through the interface. Data collected from the system is uplinked and available to be digested in an enterprise cloud or data platform.

The initial communications layer for robots is EtherCAT but others may be supported in the future. Any communication layer must meet benchmarks for:
Latency
Bandwidth

Separate from the communication layer, the robot interface defines standard status and control data elements such as (but not limited to):
Torque control interface
Unified Errors and Warnings Interface
Kinematics/Dynamics Information
Robot Metadata
   Mileage
   Date of Manufacture/Part Replacement

In various embodiments, a robotic interface and distributed controller architecture as disclosed herein may be extended to incorporate peripherals that implement the disclosed robotic interface:
Gripper
Conveyor Belts and other material handling w/sensing
Compute, including edge compute for vision and compute intensive peripherals
Networking
Safety Systems and interfacing
2D/3D Camera and data transfer
Perception sensors like force sensors, radar and other sensors

In various embodiments, a “plug and play” or similar feature may be provided. A local controller implementing a standard interface may be configured to establish communication to a newly connected device (sensor, peripheral device, etc.); determine its identity, features, and requirements; establish trust and secure communications; and report to higher level nodes (e.g., robot level controller, remote control computer, enterprise data platform) information about the added device. Once configured, the local controller may be able to control operation of the device, e.g., by dynamically determined and setting operating parameters.

In various embodiments, a distributed controller as disclosed herein controls a robot and/or a local instrumentality thereof via torque control.

The simplest and most common way to control robots is using position control. Position control typically results in very stiff motions. In fact, such stiff motion is so common in robots that even when humans move in this stiff manner, they are said to be demonstrating “robotic motion”. Such robots can be said to maintain a high impedance to ensure stiff control of the position.

In various embodiments, techniques disclosed herein are used to deliver fluid robot motion. The complete dynamics (forces and torques) of the robot are controlled, instead of just positions. In some embodiments, EtherCAT provides the high bandwidth low latency communications channel to enable this granular control of fluid motion for the robotics interface disclosed herein.

A control AI can set the impedance low to move safely without causing damage, e.g., when obstacles are nearby, and raise the impedance when needed to lift heavy objects. This is just like humans who move carefully when reaching to find the right item in the cupboard to avoid scattering the items but tighten up when we lift something heavy out of the cupboard. A robot control AI can achieve this variable impedance objective using torque control of the joints. Torque control results in minimum effort to control forces and accelerations and also have better compliance with the environment. Since torque control can apply the right amount of force needed to move, it means the robot can avoid crushing an object, for example when positioning the gripper on a box.

Typically, when using position control, robots have to conservatively throttle the system so the internal constraints are not breached. In various embodiments, techniques and structures disclosed herein are used to provide and perform torque control, which enables robot constraints to be evaluated within the control algorithms so that robots can be driven at full speed (with the robot's internal throttling, if any, disabled) without fear of breaching any hardware constraints, fully leveraging scheduling and motion control algorithms to maximize a robot's utilization. This approach results in smoother error free motion and simpler application design, with the highest reliability of the robots that the OEM (robot manufacturer) can dictate.

FIG. 1 is a diagram illustrating an embodiment of a robotic system comprising a distributed robotic controller. In the example shown, robot 100 comprises a robotically controlled mobile chassis 102 on which robotic arm 104 having suction-type end effector 105 on its distal end is mounted. Central controller 106 provides higher level control and planning, e.g. to operate one or more of chassis 102, robotic arm 104, and end effector 105 to pick, move, and place items. Communication with higher level control computers and/or external sensors, such as a camera mounted in a work area in which robot 100 is operating (not shown in FIG. 1) is provided via a wireless communication interface 107, e.g., Wi-Fi, radio, or other communications.

In various embodiments, battery 108 supplies DC current via a shared DC bus to drive the respective motors for the wheels comprising one or more of mobile chassis 102 and the joints 115, 117, 119, 122 comprising robotic arm 104.

In the example shown in FIG. 1, each of the four wheels of the mobile chassis 102 has a local controller, e.g., 110, 112, as do each of the joints 115, 117, 119, 122 of robotic arm 104, e.g., local or distributed controllers 114, 116, 118, and 120, respectively. A higher-level control logic, in this example implemented in/by/as controller 106, provides/updates policies for each local controller and/or provides commands to each local controller, to be performed locally in a manner determined and/or permitted by the local policy, e.g., to result in the base and arm being used to pick and place an item, for example.

In various embodiments, robot 100 may respond to a communication received via antenna 107, for example, to accomplish a high-level objective, such as to unload a truck or container or stack a set of items on a pallet. Controller 106 may generate or update a plan, e.g., to stack the next n items in a specific order and each in a corresponding placement on the pallet. The plan may be broken down to subplans, e.g., to move near, pick, translate to a destination location, and place a given item. To implement the subplan, controller 106 may determine for each of the wheels comprising mobile chassis 102 and each comprising robotic arm 104 a time-synchronized sequence of torques to be applied to a motor associated with that wheel or joint. For each wheel and each joint, the controller 106 may send to the associated local controller (e.g., 110, 112, 114, 116, 118, 120) the timing information and sequence of torques to be applied by the motor at that wheel or joint.

Each of the local controllers may be configured to control an associated motor driver to apply the prescribed torque(s). For example, DC power may be supplied via a shared DC bus. Local torque sensor readings may be received and processed as disclosed herein, e.g., according to a current policy, to increase/decrease the current being supplied to the motor, as/if needed, to achieve/maintain the requisite torque. Since each local controller is near the motor it controls and the sensor(s) it relies on as feedback for control, the control signals can be updated much more quickly than if the sensors readings had to be communicated all the way to the central controller 106 and then commands generated by the central controller 106 had to be communicated back to the motor controller associated with and typically located near the motor it controls.

For local controller 120, in some embodiments, the torques to be applied by each of three motors, each associated with a degree of freedom (e.g., roll, pitch, yaw) of the wrist joint, may be provided and/or commands to be implemented by the end effector 105, e.g., to apply suction to a prescribed set of suction cups. In some alternative embodiments, local controller 120 may represent a plurality of collocated local controllers, one for each motor (degree of freedom) and/or one or more for the end effector.

In various embodiments, commands may be communicated by controller 106 to the respective local controllers 110, 112, 114, 116, 118, 120 via EtherCAT or other wired or wireless connections.

In various embodiments, one or more local controllers in addition to those shown in FIG. 1 may be included. For example, in some embodiments, robot 100 includes a camera or other sensor mounted on a pole or on robotic arm 104 and robot 100 includes an additional local controller dedicated to controlling the camera or other sensor. For example, the additional local controller may control the frame rate of a camera or the sampling rate of another sensor, such as to generate information updates at a higher rate during a critical or risky phase of a task.

FIG. 2 is a block diagram illustrating an embodiment of a distributed robotic controller. In various embodiments, each of the local controllers 110, 112, 114, 116, 118, 120 may be implemented as an instance of local controller 202 of FIG. 2. In the example shown, local controller 202 includes a communication interface 204 configured to receive commands from and report status and information to a central controller, such as controller 106 of FIG. 1. Local controller 202 includes control logic 206 configured to make control decisions about how to use a local motor driver to supply DC current to a local motor, e.g., a joint motor, to achieve and/or maintain a required torque that the central controller has indicated is to be applied at that joint (or wheel, etc.). The control logic 206 uses a model 208 of the local joint, motor, etc. to make control decisions.

Control may be implemented as indicated by a policy or other configuration data stored in memory 210 and/or embodied in model 208, such a machine learning model, adjusted weights for such a model, etc. Torque sensor and/or other sensor readings may be received via a sensor interface 212 and processed by digital signal processing (DSP) module 214 to provide a stream of sensor data to control logic 206 at a rate that matches (or better matches) the speed at which control logic 206 makes control decisions.

In some embodiments, sensor interface 212 may receive sensor readings from sensors physically collocated with the local controller 202 and the motor(s) it controls, such as a torque sensor associated with a motor controlled by the local controller. In some embodiments, sensor interface 212 may receive sensor readings from sensors physically remote from the local controller 202 and the motor(s) it controls, e.g., from other joints. In some embodiments, each instance of local controller 202 may respond in a corresponding way to an event, such as torque readings associated with the end effector or another part of the robot coming into contact with an obstacle in the workspace. In various embodiments, the joints each may respond independently and/or in coordination, such as by causing the end effector to move more slowly and/or to be compliant or somewhat compliant (e.g., backing off if pushed against strongly). Factors such as the robot's current pose, environment, load, etc. may be taken into account, e.g., according to a policy being applied at each joint and/or throughout the robot. For example, joints nearer the shoulder may be used more than joints nearer the end effector, or vice versa, depending on the context, current policy/policies, etc.

FIG. 3 is a block diagram illustrating an embodiment of a distributed robotic controller. In various embodiments, each of the local controllers 110, 112, 114, 116, 118, 120 may be implemented as an instance of local controller 302 of FIG. 3. In the example shown, controller 302 includes a field programmable gate array (FPGA) chip 304 configured to make control decisions and issue associated commands to implement commands or instructions received from a robot level (or other central) controller 306. In other embodiments, FPGA 304 may comprise a chip or processor other than an FPGA, such as general use microprocessor, an ASIC, a DSP, a flash controller, etc. Control logic implemented on FPGA 304 sends commands to motor driver 308 to cause motor driver 308 to supply current to an associated motor from a DC bus that is shared with one or more other motors (e.g., other joints, wheels, etc.). Sensor data received via sensor interface 310, e.g., torque sensor data, is provided to a DSP module implemented on FPGA 304, which performs digital signal processing according to a current policy as stored in policy data store 312. For example, robot level controller 306 may provide and/or update a policy.

In the example shown in FIG. 3, the local controller 302 includes FPGA 304 configured to receive and implement commands and operate according to policies received from a higher level (e.g., robot level) controller 306. FPGA 304 performs DSP on sensor data received via sensor interface 310 and provides torque/current commands to motor driver 308, which supplies current to an associated joint motor. (See description below, with respect to FIG. 4, of a “share” DC bus, used to supply current to a motor to drive the motor and to which current may be supplied, e.g., regenerative current produced by the motor when braking).

In various embodiments, in a robotic system as disclosed herein each of a plurality of motors may be driven by controllers connected to a shared DC bus. Using a shared bus, each controller and integrated and/or associated driver can draw and supply current from the bus and, conversely, divert/direct regenerated current onto the shared bus while braking.

When braking, typically a braking resistor is used to dissipate energy in the form of heat, e.g., to protect the driver and other power electronics. In some embodiments, use of a shared bus enables a single appropriately sized braking resistor to be used to dissipate energy from any/all motors, saving on weight and cost.

In some embodiments, use of a shared bus may enable energy generated when braking on a first joint/motor to help power one or more other motors, and vice versa.

Taken together, the above advantages of a shared DC bus may facilitate smaller battery size/weight and/or longer battery life.

FIG. 4 is a diagram illustrating an embodiment of a robotic system or subsystem 400 comprising a distributed robotic controller and a shared DC bus. In the example shown, each of a plurality of motors 1 to n, represented in FIG. 4 by motors 410, 412, and 414, is controlled by a local/distributed controller 422, 424, 426 based on local sensors 428, 430, 432, as disclosed herein, by causing a local motor driver 416, 418, 420 to supply current drawn from a shared DC bus 402, enabling a single AC source 404, AC to DC rectifier 406, and filter 408 to be used to supply clean, stable DC voltage to the shared DC bus 402.

In the example shown, a single braking resistor 434 and associated switch 436 is provided to be used to dissipate excess energy that has been put back onto the shared DC bus 402, e.g., during simultaneous braking of a plurality of the motors 410, 412, 414. If some motors are regenerating (i.e., sending current onto the shared DC bus 402 while others are drawing current, less energy or no energy may need to be dissipated via braking resistor 434 and associated switch 436 may remain open, as shown in FIG. 4.

In addition, in the example shown, FIG. 4 includes an optional rechargeable battery 438, which may be charged using regenerative techniques, when more current is being put onto DC bus 402 than is being drawn from it. Once the battery 438 is fully charged, excess current may be dissipate via resistor 434 by closing switch 436.

FIG. 5 is a block diagram illustrating an embodiment of a distributed robotic controller. In the example shown, local control subsystem 502 includes a local controller 504 that receives commands via communication interface 506 (e.g., EtherCAT) from a central robot level controller 508. The local controller 504 may comprise control logic and/or perform DSP processing on sensor data, e.g., as described above in connection with FIGS. 2, 3, and 4. In various embodiments, local controller 504 sends commands 510 to an associate motor controller to apply the torque(s) the local controller 504 has been instructed to apply at the local motor. In this example, the local controller 504 makes control decisions and/or processes sensor data (not represented in FIG. 5) in a manner indicated by a current policy. In this example, controller 504 toggles between a policy stored in a first location, e.g., Location A 512, and a policy stored in a second location, e.g. Location B 514, as represented conceptually by switch 516. In the state shown, controller 504 has been commanded, e.g., by robot level controller 508, to make control decisions and/or process sensor signals as indicated by a policy store in the first location 512.

The architecture as shown in FIG. 5, in various embodiments, enables the robot level controller 508 to prepare to implement a new policy for local controller 504 by writing the new policy to the second location 514 and then instructing the local controller 504 to toggle over to reading its policy from the second location 514. The next change could be made by writing a new policy to the then unused first location and toggling back to that location, and so on as/if needed. In this way, robot level controller 508 can control both the content and the timing of changes between policies very precisely.

FIG. 6A is a flow diagram illustrating an embodiment of a process to control a robot via a distributed robotic controller. In various embodiments, the process 600 of FIG. 6A may be performed by a robot level or other higher-level controller, such as controller 106 of FIG. 1. In the example shown, at 602, a plan to pick, move, and place an item is determined. For example, the plan may specify for each of a plurality of wheels and/or joints a corresponding sequence of motor torques to be applied at that wheel or joint. At 604, a set of torques to be applied at a given motor is sent to its associated local controller. At 606, progress of the pick, move, and place task is monitored, e.g., using computer vision and/or other sensors, and the planned sequences of torques to be applied at the respective motors is updated as/if needed.

At 608, optionally, e.g., if observed conditions warrant, a change in a policy being applied by a given local controller may be triggered. For example, an update policy may be stored in a memory location associated with the local controller and the local controller may be prompted to switch over to applying the updated policy. Examples of conditions that may cause the robot level controller to prompt a local controller to switch to a new policy include work near obstacles and encountering unexpected risks, such as presence of a human, other robot, material handling equipment, etc. For example, sensor data may be processed to be supplied at a higher rate, enabling decisions to be made more quickly and/or on more recent information.

FIG. 6B is a flow diagram illustrating an embodiment of a process to participate in control of a robot as a local controller comprising a distributed robotic controller. In various embodiments, the process 620 of FIG. 6B may be performed by a local controller, such as local controllers 110, 112, 114, 116, 118, and 120 of FIG. 1. In the example shown, at 622, a time series or other sequence of torques to be applied at/by a motor controlled by the local controller is received. At 624, a local motor driver is used to apply the sequence of torques, including by monitoring the actual torques as measured by one or more sensors and adjusting the current being supplied to the motor via the motor driver as/if needed to maintain/achieve the required torque. At 626, any changes or updates to the sequence of torques, received for example from a robot level controller, are implemented. At 628, optionally, an indication to change to a new policy, e.g., for control and/or signal processing of local sensor readings, etc., may be received and if so is implemented.

FIG. 7 is a flow diagram illustrating an embodiment of a process to participate in control of a robot as a local controller comprising a distributed robotic controller. In various embodiments, the process 700 of FIG. 7 may be performed by a local controller, such as local controllers 110, 112, 114, 116, 118, and 120 of FIG. 1. In the example shown, at 702, sensor data is received at a rate the sensor is configured to produce and communicate sensor data. At 704, digital signal processing (DSP) is performed to produce a stream of sensor data at a rate that (better) matches a rate at which control decisions are made, communicated, and/or implemented. At 706, control logic is used to make and implement decisions based on the DSP-processed sensor data produced at 704. If a change in decision making and/or sensor data rate is indicated at 708, then at 710 the digital signal processing of the sensor data is adjusted to achieve the new data rate. Processing continues until done (710), at which time process 700 ends.

### Enterprise Data Platform Capabilities

In various embodiments, a distributed robot controller as disclosed herein may be used in the context of and/or in conjunction with a fleet of robots for which an Enterprise Data Platform for Fleet Management of robotic applications and API access for hardware data is provided, in various embodiments, through standardization of communication and metadata. Robotic application data is captured and displayed in an enterprise suite of tooling and UIs. When a hardware OEM implements a robotic system interface, as disclosed herein, additional low-level hardware data can be collected and stored. This data is used, in some embodiments, for real-time hardware analytics and alerts, for understanding usage patterns and failure modes in the field, and even for improving robot designs. Ultimately, this mechanism provides the data needed to support an intelligent on-demand service business model for hardware OEMs that cuts a lot of unnecessary cost.

In some embodiments, simulation-based design tools are provided and/or supported. These tools allow a Robot OEM to validate and benchmark end-use cases against their robots. They can understand the sensitivity of design constraints against end use goals such as PPH and robot-reach as well as against midway goals such as trajectory speed and tracking, grip strength, singularities and ease of motion planning. Ultimately this input can be used to choose the optimal robot for applications as well as to custom-design a robot optimized on price-performance for a specific market.

Some examples of enterprise platform capabilities that are unlocked using techniques disclosed herein:
Trust in the HW system from early deployment
   Suite of tests and reliability benchmarks
   Indication of which HW malfunctioned and where
   Compatibility between HW on the field and in development
   Knowledge of HW deployments with versions, locations and replacements
Metrics on HW
   Virtual odometers on lifetime
      Distance traveled
      Torques/peak forces/actuation effort
      collisions and other events
      Duty cycle
   Thermals and real-time monitors
   Field-operations view of entire robot fleet and patterns that emerge
Understanding of constraints in the field and in-development
   Simulations of system end to end performance
   Hardware constraint sensitivity
   How current applications could change with new HW
   Cost-performance tradeoff and picking the least performance sensitive cost optimizations
   Understanding deployed robot system degradation

### Advantages of Using Techniques Disclosed Herein to Provide Torque Control

In various embodiments, a distributed robot controller as disclosed herein enables torque control to be implemented in a black-box free way to specify the full motion (position, velocity, acceleration) and force profile of a robot in a pure position, pure force, or hybrid force/motion control modes. Including, in various embodiments, one or more of:
Directly command and account for actuator limits
Directly understand if commands are achievable (or has some specific torque profile) and exactly the time it takes for a motion.
   Directly control velocity at specific times of the trajectory
   No black box timing and lag for motion
Directly switch between different controllers or force/motion hybrid modes smoothly, without stopping

Other benefits may include, in various embodiments, one or more of:
Very low latency from command->sensor->command
   Very important for reacting from the environment and not crushing the environment
Allows for force control
   Exactly how much the robot is applying to the environment
   Stiff robot positional control will crush packages and harm environments. No soft touch
   Allows for hybrid force/motion—where you press and squeeze in certain directions while moving or jiggling in other directions
      Absolutely fundamental for packing boxes tightly
Allows for adaptive motions, or timing-oriented motion
   Scene changes, motion needs to adapt smoothly or fast
      Object gets in the way of pick (falling object from pick chute for ex.)
      Place location needs to be updated on the fly (vision update is slow and needs to update mid trajectory)
   Place with specific velocity on specific locations
      Place into a slot on a moving tilt tray, for example
Allows for optimization methods for robot control
   Allows for stopping and starting the robot in a critical way, and allows to time to synchronize and optimize for the task
   Accounts for obstacles, kinematics, dynamics of the robot to create the best trajectories for the scene
Allows for end-to-end machine learning
   Allows machine learning to utilize the whole robot dynamics and leverage physics like throwing, momentum, contact, and singularity.
Allows for instantaneous profile of impedance and control law
   Impedance and closed loop policy can be changed on the fly, to account for uncertainty in the environment
   Control law can be changed as well dynamically and smoothly (gains and control equation)
Controlling torque can properly let us control and optimize for:
   Total energy use in the system
   Instantaneous peak power
   Jerk
   Average and Peak torque
Use momentum and gravity to your advantage for going above payload limits (but still under torque limits)

In various embodiments, techniques disclosed herein may be used to control a robotic arm or other robot, via a distributed controller, with greater speed and precision than using a single, central robotic controller.

Although the foregoing embodiments have been described in some detail for purposes of clarity of understanding, the invention is not limited to the details provided. There are many alternative ways of implementing the invention. The disclosed embodiments are illustrative and not restrictive.

What is claimed is:

1. A robotic system, comprising:
a plurality of motors, each associated with a corresponding degree of freedom of a robot comprising the robotic system;
a plurality of local controllers, each associated with a corresponding motor included in the plurality of motors; and
a robot level controller coupled communicatively with each of the local controllers included in the plurality of local controllers and configured to determine a plan to operate the plurality of motors to cause the robot to perform a task, wherein the plan includes for each of the plurality of motors a set of one or more torques to be applied at or by the motor and wherein the robot level controller is further configured to send to each of the local controllers included in the plurality of local controllers at least the set of one or more torques associated with the motor with which that local controller is associated; and
wherein each of the local controllers is configured to control the motor with which it is associated to achieve the set of one or more torques associated with the motor with which that local controller is associated.

2. The robotic system of claim 1, wherein the robot comprises a robotic arm having a plurality of links joined serially by one or more intervening joints and each of at least a subset of the motors is associated with a corresponding joint of the robotic arm.

3. The robotic system of claim 1, wherein the robot comprises a robotic arm mounted on a mobile chassis having a plurality of wheels or other motive elements and each of at least a subset of the motors is associated with a corresponding one or more of the wheels or other motive elements.

4. The robotic system of claim 1, wherein the robotic system further includes a camera or other sensor and the plurality of local controllers further includes a local controller configured to control the camera or other sensor.

5. The robotic system of claim 1, wherein each of at least a subset of the plurality of local controllers has associated therewith one or more local sensors and each local controller in the at least a subset of the plurality of local controllers is configured to use sensor data from the one or more local sensors associated with that local controller to control the motor associated with that local controller.

6. The robotic system of claim 5, wherein the sensor comprises a torque sensor.

7. The robotic system of claim 5, wherein the sensor is configured to provide sensor data at a first rate of information and the local controller is configured to process the sensor data to produce a processed sensor data at a lower rate of information.

8. The robotic system of claim 7, wherein the processing comprises digital signal processing (DSP).

9. The robotic system of claim 7, wherein the lower rate of information is associated with a rate at which the local controller makes control decisions with respect to control of the motor with which the local controller is associated.

10. The robotic system of claim 7, wherein the processing is performed at least in part according to a local policy.

11. The robotic system of claim 10, wherein the local policy is received from the robot level controller.

12. The robotic system of claim 10, wherein the local policy comprises a first local policy stored in a first memory location associated with the local controller and the robot level controller is configured to cause the local controller to transition from implementing the first local policy to implementing a second local policy at least in part by storing the second local policy in a second memory location associated with the local controller and causing the local controller to read the second local policy from the second memory location.

13. The robotic system of claim 1, wherein each of the plurality of motors has associated therewith a corresponding motor driver controlled by the local controller with which that motor is associated.

14. The robotic system of claim 1, wherein each of the plurality of motors is driven by direct current (DC) power supplied via a shared DC bus.

15. The robotic system of claim 14, wherein each of the plurality of motors is connected to supply regenerated current back onto the shared DC bus.

16. The robotic system of claim 15, wherein the shared DC bus has associated therewith a braking resister configured to dissipate as needed excess net current placed on the DC bus by one or more of the plurality of motors.

17. A method of controlling a robotic system comprising a plurality of motors, each associated with a corresponding degree of freedom of a robot comprising the robotic system; a plurality of local controllers, each associated with a corresponding motor included in the plurality of motors; and a robot level controller coupled communicatively with each of the local controllers included in the plurality of local controllers, the method comprising:
determining a plan to operate the plurality of motors to cause the robot to perform a task, wherein the plan includes for each of the plurality of motors a set of one or more torques to be applied at or by the motor; and
sending to each of the local controllers included in the plurality of local controllers at least the set of one or more torques associated with the motor with which that local controller is associated;
wherein each of the local controllers is configured to control the motor with which it is associated to achieve the set of one or more torques associated with the motor with which that local controller is associated.

18. The method of claim 17, wherein the robot comprises a robotic arm having a plurality of links joined serially by one or more intervening joints and each of at least a subset of the motors is associated with a corresponding joint of the robotic arm.

19. The method of claim 17, wherein each of at least a subset of the plurality of local controllers has associated therewith one or more local sensors and each local controller in the at least a subset of the plurality of local controllers is configured to use sensor data from the one or more local sensors associated with that local controller to control the motor associated with that local controller.

20. A computer program product to control a robotic system comprising a plurality of motors, each associated with a corresponding degree of freedom of a robot comprising the robotic system; a plurality of local controllers, each associated with a corresponding motor included in the plurality of motors; and a robot level controller coupled communicatively with each of the local controllers included in the plurality of local controllers, the computer program product being embodied in a non-transitory computer readable medium and comprising computer instructions for:
determining a plan to operate the plurality of motors to cause the robot to perform a task, wherein the plan includes for each of the plurality of motors a set of one or more torques to be applied at or by the motor; and
sending to each of the local controllers included in the plurality of local controllers at least the set of one or more torques associated with the motor with which that local controller is associated;
wherein each of the local controllers is configured to control the motor with which it is associated to achieve the set of one or more torques associated with the motor with which that local controller is associated.
